(19) United States
(12) Patent Application Publication
(10) Pub. No.: US 2024/0314682 A1
(43) Pub. Date: Sep. 19, 2024

(54) RESOURCE MANAGEMENT FOR MULTI-AP COORDINATION IN WIRELESS NETWORKS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Allen, TX (US); Vishnu Vardhan Ratnam, Plano, TX (US); Yue Qi, Plano, TX (US); Elliot Jen, Taipei City (TW)

(21) Appl. No.: 18/592,231

(22) Filed: Feb. 29, 2024

Related U.S. Application Data
(60) Provisional application No. 63/452,298, filed on Mar. 15, 2023.
(60) Provisional application No. 63/455,473, filed on Mar. 29, 2023.
(60) Provisional application No. 63/457,989, filed on Apr. 7, 2023.

(51) Int. Cl. H04W 48/20; H04W 24/08; H04W 84/12

(52) U.S. Cl. CPC H04W 48/20; H04W 24/08; H04W 84/12

(57) ABSTRACT

A wireless communication network includes an access point (AP) device, the AP device may receive information related to multi-AP coordination from a station (STA), select at least one other AP that is not affiliated with the AP device based on the information, communicate with the at least one other AP to perform multi-AP coordination, and communicate with the STA in coordination with the at least one other AP.

### CROSS-REFERENCE TO RELATED APPLICATIONS

This application claims the benefit of priority from U.S. Provisional Application No. 63/452,298, entitled “TIME AND FREQUENCY DIVISION USING LOGICAL AP MLD FOR MULTI-AP OPERATION IN NEXT GENERATION WI-FI NETWORKS,” filed Mar. 15, 2023, U.S. Provisional Application No. 63/455,473, entitled “RESOURCE MANAGEMENT FOR MULTI-AP COORDINATION IN NEXT GENERATION WI-FI NETWORKS” filed Mar. 29, 2023, and U.S. Provisional Application No. 63/457,989, entitled “LATENCY REDUCTION IN MULTI-AP COORDINATION FOR NEXT GENERATION WI-FI NETWORKS”, filed Apr. 7, 2023, which are incorporated herein by reference in their entirety.

### TECHNICAL FIELD

This disclosure relates generally to a wireless communication system, and more particularly to, for example, but not limited to, multi-AP coordination in wireless communication systems.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides an access point (AP) device in a wireless network, the AP device comprising a memory, and a processor coupled to the memory. The processor is configured to receive information related to multi-AP coordination from a station (STA). The processor is configured to select at least one other AP that is not affiliated with the AP device based on the information. The processor is configured to communicate with the at least one other AP to perform multi-AP coordination. The processor is configured to communicate with the STA in coordination with the at least one other AP.

In some embodiments, the information is received from the STA in an unsolicited manner or the information is solicited by the AP device.

In some embodiments, the information includes interference information of an interference from the at least one other AP to the STA.

In some embodiments, the processor is configured to select the at least one other AP to perform multi-AP coordination based on a level of interference.

In some embodiments, the processor is configured to select the at least one other AP to perform multi-AP coordination when the level of interference is above a threshold.

In some embodiments, the processor is configured to identify an interference based on a link on which the information is provided from at the STA.

In some embodiments, the processor is configured to select the at least one AP based on traffic information included in the information, where the traffic information provides performance metrics that need to be met for a traffic stream or a traffic identifier that identifies a type of traffic that needs to be served for the traffic stream.

In some embodiments, the processor is configured to calculate a metric that predicts a change in performance from performing the multi-AP coordination, and determine that the metric satisfies a threshold.

In some embodiments, the information comprises information indicating expected improvement at the STA if a source of interference is eliminated, where the improvement is at least one of an expected improvement in signal to interference and noise ratio (SINR), a data rate improvement, a throughput improvement, or a latency improvement.

In some embodiments, the processor is configured to announce information related to membership for multi-AP coordination to the STA, where the information related to the membership comprises information regarding one or more APs involved in the multi-AP coordination.

One aspect of the present disclosure provides a station (STA) device in a wireless network. The STA device comprises a memory and a processor coupled to the memory. The processor is configured to transmit information related to multi-AP coordination to a first AP, where the information comprises interference information that identifies a second AP that is not affiliated with the first AP. The processor is configured to receive configuration information from the first AP, where the configuration information has been configured based on a performed multi-AP coordination with the second AP.

In some embodiments, the information is transmitted in an unsolicited manner or the information is solicited by the first AP.

In some embodiments, the information includes interference information of an interference from the second AP.

In some embodiments, the information is transmitted on a same link on which an interference is experienced from the second AP.

In some embodiments, the information includes traffic information, where the traffic information provides performance metrics that need to be met for a traffic stream or a traffic identifier that identifies a type of traffic that needs to be served.

In some embodiments, the information comprises information indicating an expected improvement if a source of interference is eliminated, where the improvement is at least one of an expected improvement in signal to interference and noise ratio (SINR), a data rate improvement, a throughput improvement, or a latency improvement.

In some embodiments, the processor is configured to receive information related to membership for multi-AP coordination from the AP, where the information related to the membership comprises information regarding one or more APs involved in the multi-AP coordination.

One aspect of the present disclosure provides a computer-implemented method for facilitating communication in a wireless network. The method comprises receiving, by an access point (AP), information related to multi-AP coordination from a station (STA). The method comprises selecting, by the AP, at least one other AP that is not affiliated with the AP based on the information. The method comprises communicating, by the AP, with the at least one other AP to perform multi-AP coordination. The method comprises communicating, by the AP, with the STA in coordination with the at one other AP.

In some embodiments, the information is received from the STA in an unsolicited manner or the information is solicited by the AP device.

In some embodiments, the information includes interference information of an interference from the at least one other AP to the STA.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 illustrates an example of a multi-AP framework in accordance with an embodiment.

FIG. 5 shows a flow chart of an example process for an STA transmitting a report to an AP in accordance with an embodiment.

FIG. 6 shows a flow chart of an example process for an AP receiving a report from an STA for multi-AP coordination in accordance with an embodiment.

FIG. 7 illustrates an SCS request frame in accordance with an embodiment.

FIG. 8A shows a concept of a logical AP MLD in accordance with an embodiment.

FIG. 8B shows a concept of a logical AP MLD in accordance with another embodiment.

FIG. 9 illustrates an example of multiple AP MLDs deployed in an area.

FIG. 10 shows a local stack in accordance with an embodiment.

FIG. 11 shows how the parallel stack and the local stack operate in accordance with an embodiment.

FIG. 12 shows operations of parallel stack in networks supporting multi-AP coordination in accordance with an embodiment.

FIG. 13 shows a flow chart of an example process for setting up a logical AP MLD for MAP coordination in accordance with an embodiment.

FIG. 14 shows a flow chart of an example process for static setting using a logical AP MLD in accordance with an embodiment.

FIG. 15 shows a flow chart of an example STA side process for dynamic setting in accordance with an embodiment.

FIG. 16 shows a flow chart of an example process for dynamic setting using a logical AP MLD in accordance with an embodiment.

FIG. 17 shows a flow chart of an example process for an STA to report interference in accordance with an embodiment.

FIG. 18 shows a flow chart of an example process for an AP side triggering for collection of interference reports from non-AP MLDs in accordance with an embodiment.

FIG. 19 shows a flow chart of an example process for switching between a local and parallel stack in accordance with an embodiment.

FIG. 20 shows a flow chart of an example process for capability advertisement for an AP MLD in accordance with an embodiment.

FIG. 21 shows a flow chart of an example STA side process to enable latency reward assessment at the AP in accordance with an embodiment.

FIG. 22 shows a flow chart of an example AP side process for assessing if its actions resulted in a reward in accordance with an embodiment.

FIG. 23 shows a flow chart of an example STA side process to enable the AP to assess its multi-AP coordination requirement in accordance with an embodiment.

FIG. 24 shows a flow chart of an example AP side process for membership announcement for multi-AP coordination in accordance with an embodiment.

FIG. 25 shows a flow chart of an example AP side process for capability advertisement in accordance with an embodiment.

FIG. 26 shows a flow chart of an example STA side process for advertising a capability in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

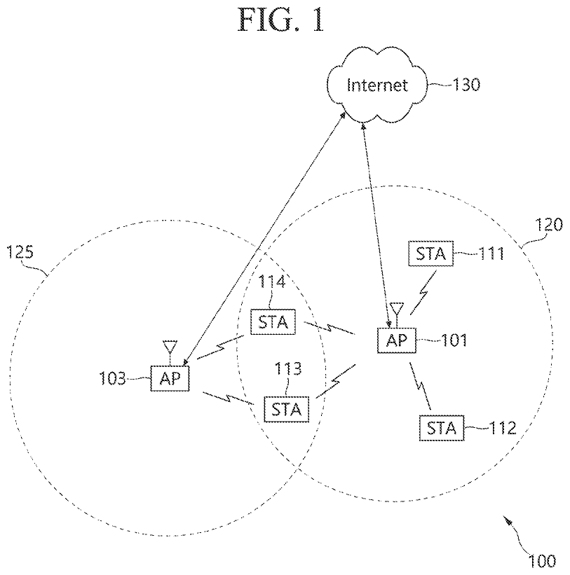

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

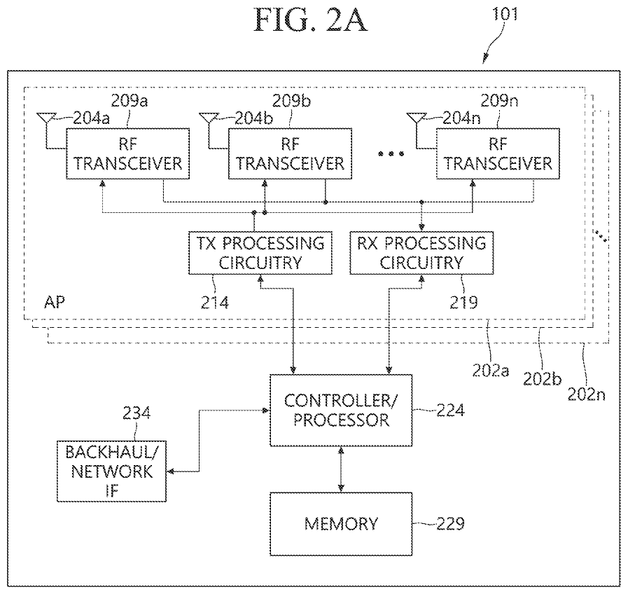

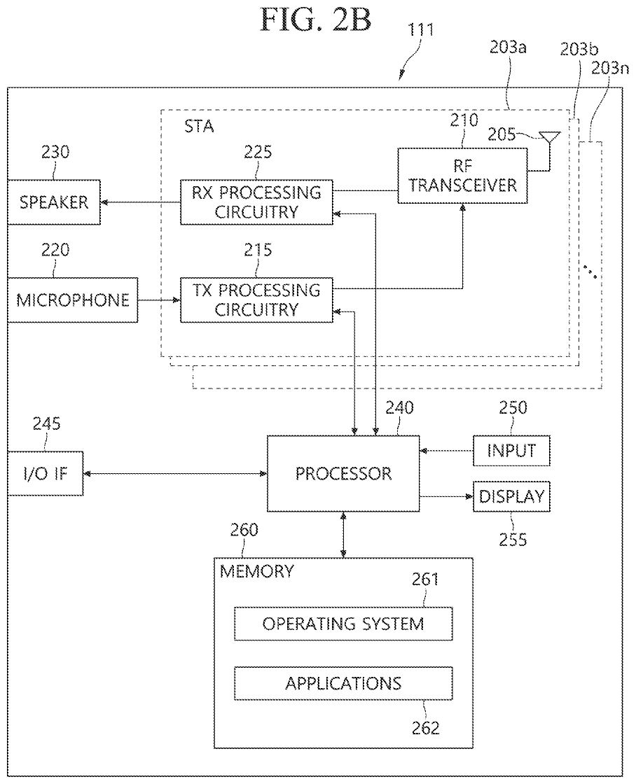

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

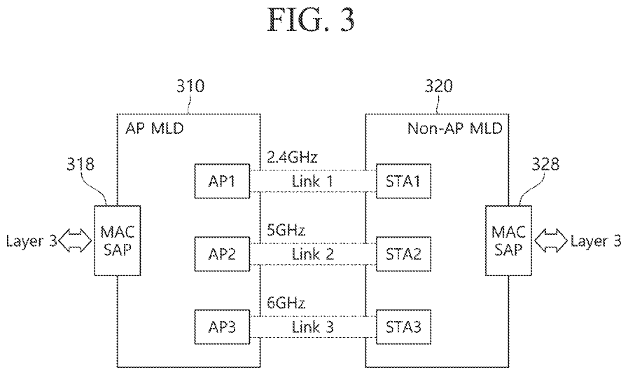

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA I may set up Link I which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications” and ii) IEEE P802.11be/D3.0, “Wireless LAN Medium Access Control (MAC) and Physical Layer (PHY) Specifications.”

There has been an increasing demand for wireless network connectivity in indoor environments. To help address these increased demands, network managers have typically been increasing the number of APs being deployed within the indoor environment. These types of configurations can provide a multi-AP (MAP) network configuration as multiple APs can be utilized to service the traffic demands of the STAs within the network. However, these multi-AP configurations can experience certain performance issues, including issues related to signal interference between APs and STAs, among others. In particular, co-deployed APs in a Basic Service Set (BSS) typically employ limited forms of coordination as related to providing the various network functionalities. As a result, there can be interference from a neighboring AP which can diminish the network quality. In order to minimize the various performance issues that may be encountered in multi-AP configurations, multi-AP coordination has been under consideration in the IEEE 802.11 Ultra High Reliability (UHR) Study Group which has been converted to the task group, TGbn.

Systems in accordance with many embodiments can provide for resource management in multiple-AP networks using multi-AP coordination. The multi-AP coordination can include APs communicating with each other in order to determine an optimal network configuration parameters, including configuring parameters related to managing traffic between the APs and STAs on the network. The multi-AP coordination can include communications between AP to AP and/or communications between one or more APs and a central controller.

Performing a multi-AP coordination process may result in various overhead costs related to the data management and complexity of managing traffic between the multiple APs and the STA, and many embodiments can optimize the overhead costs in order to provide an improvement in the overall network performance.

The overhead costs that can be incurred during multi-AP coordination can include an increase in traffic on the network, including an increase in a backhaul load of the network. The overhead can include costs related to the exchange of data frames amongst the APs. In particular, APs can exchange different types of data frames during coordination, including different forms of signaling frames, data frames transferred to multiple APs (e.g., as in joint transmission (JTX)), among others. Likewise, these overhead costs can increase with increasing number of APs and non-AP STAs involved in the coordination. Accordingly, many embodiments can weigh the overhead costs of performing a coordination against the benefit/improvements that can be achieved in order to determine whether to perform the multi-AP coordination. Furthermore, many embodiments can optimize the multi-AP coordination process to minimize the network resources (APs, STAs, among others) that may need to be involved in coordination, which can minimize the overhead costs that may be incurred.

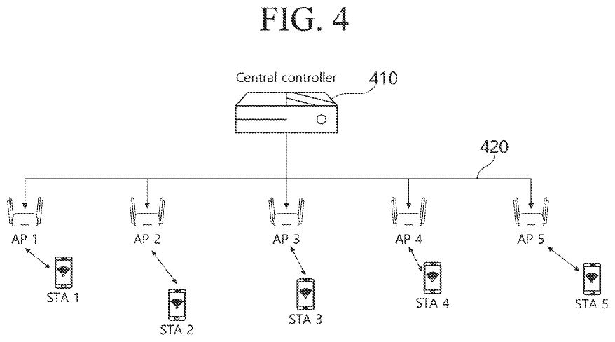

FIG. 4 illustrates a typical multi-AP framework and is provided to illustrate the various overhead issues that may need to be taken into consideration in performing multi-AP coordination. The multi-AP framework includes a central controller 410 that can enable coordination between multiple co-deployed APs (AP1 to AP5). The central controller 410 can be connected to the co-deployed APs over a backhaul network 420. Each AP can communicate with one or more STAs associated with it. As illustrated, AP1 is associated with STA1, AP2 with STA 2, AP3 with STA 3, AP4 with STA4, and AP5 with STA5. As illustrated in this example, joint transmission can be employed for reducing interference amongst devices. A number of frames and data signals may need to be exchanged amongst the APs. These can include, but are not limited to, trigger frames for triggering channel sounding operation, channel sounding data collection from users that can be communicated to a central controller, and data transmission of users from the central controller to each AP for each user in the network, among others.

As the number of APs that participate in MAP coordination and/or the number of STAs that are served with MAP coordination increases, the amount of signaling and data exchanged over the multi-AP framework can increase. Likewise, data management complexity can increase based on the types of traffic being handled by the APs and STAs. In particular, each AP can communicate with a number of STAs associated with it, and each of these STAs can have their own traffic types with different latency tolerance values. Accordingly, performing multi-AP coordination may need to take into account the different latency costs and potential improvements that may arise from multi-AP coordination.

Accordingly, systems in accordance with many embodiments can perform multi-AP coordination to efficiently allocate and configure network resources in a multi-AP network while optimizing overhead costs. In particular, the multi-AP coordination can help optimize traffic on a backhaul network, data management complexity, among other costs associated with multi-AP configurations. Many embodiments can include processes that can help minimize the network resources, including the number of APs and/or STAs that may need to be involved in multi-AP coordination, which can help optimize overhead and data management complexity.

In many embodiments, multi-AP coordination can be performed by a controller device, which can be one or more devices that implements the multi-AP coordination functionality and/or interacts with APs for the purpose of multi-AP coordination. In several embodiments, a controller device can be a central controller and/or one or more of the APs involved in multi-AP coordination and serving as a master AP (e.g., one or more APs that are responsible for performing multi-AP coordination).

Many embodiments can utilize various data reports provided by one or more STAs to a coordinating AP and/or a central controller that can be used to perform multi-AP coordination. In many embodiments, an STA can generate interference related data reports and transmit the data reports to an AP which can use the data for multi-AP coordination. The data reports can be transmitted by an STA to an AP in an independent frame and/or in other types of frames. In many embodiments, the data reports provided to an AP can include one or more of the information items set out in Table 1.

TABLE 1
Information items that can be transmitted in data reports
by an STA to an AP for multi-AP coordination

| Information item | Description |
|---|---|
| BSS identifier | A field to provide information on the BSS |
| | whose interference the STA suffers from. |
| | e.g., BSSID, BSS color, among others. |
| Device identifier | A device whose transmission causes |
| | interference to the STA, e.g., AP MAC |
| | address, STA MAC address, among others. |
| Interference level | A metric to indicate the level of interference |
| | to the STA, e.g., SINR, RSSI, among others. |
| Measurement | A measurement procedure for computing |
| procedure | interference level, e.g., if interference is |
| | averaged over a certain number of intervals, |
| | this information item can indicate the interval |
| | value, the number of intervals used to do the |
| | average and a code to indicate that the procedure |
| | to make this computation is averaging. |

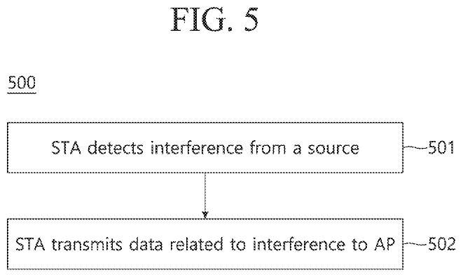

FIG. 5 shows a flow chart of an example process for an STA transmitting data reports to an AP in accordance with an embodiment. For explanatory and illustration purposes, the example process 500 may be performed by an STA (e.g., STA of FIG. 4). Although one or more operations are described or shown in particular sequential order, in other embodiments the operations may be rearranged in a different order, which may include performance of multiple operations in at least partially overlapping time periods.

The process 500 may begin in operation 501. In operation 501, an STA can detect interference from a source. For example, the STA suffers from neighboring AP interference. In operation 502, the STA can transmit data reports related to the interference to an AP. The data can be interference related data as set in e.g., Table 1. The data can be transmitted in one or more data frames.

In many embodiments, the interference data report can be transmitted by an STA periodically to an AP. In several embodiments, the interference data report can be requested by an AP by transmitting a frame requesting the data to the STA. In many embodiments, an AP can collect data from STAs associated with it and pass this information to a controller device. A controller device can analyze data from several STAs across the network and communicate with various APs on the network in order to perform the multi-AP coordination.

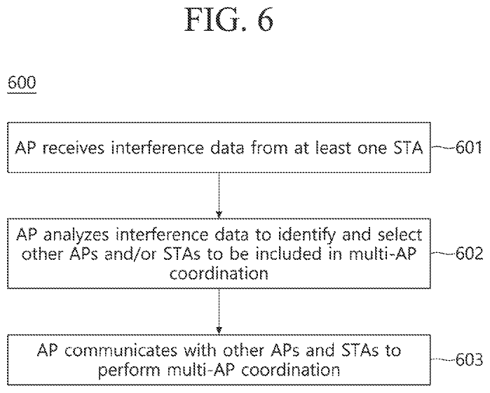

FIG. 6 shows a flow chart of an example process for an AP receiving interference data from an STA for multi-AP coordination in accordance with an embodiment. For explanatory and illustration purposes, the example process 600 may be performed by one or more APs and/or a central controller (e.g., AP of FIG. 4 and/or central controller 410 of FIG. 4). Although one or more operations are described or shown in particular sequential order, in other embodiments the operations may be rearranged in a different order, which may include performance of multiple operations in at least partially overlapping time periods.

The process 600 may begin in operation 601. In operation 601, the AP receives data (e.g., interference data) from one or more STAs.

In operation 602, the AP analyzes the data report to identify and select other APs and/or STAs to be included in multi-AP coordination based on the data.

In operation 603, the AP communicates with the other APs and STAs to perform the multi-AP coordination. In many embodiments, upon receiving the interference data from the STA, the controller device can use the data for the purpose of network resource allocation. For example, the controller or coordinating AP can identify the APs that the STA receives interference from. The controller can use this information to minimize the APs that need to be involved in multi-AP coordination. For example, only those APs that are identified as a source of interference may be included in the multi-AP coordination.

If there are multiple STAs that are going to be served at the same time via multi-AP coordination (e.g., as in JTX), then the controller can select and include in the multi-AP coordination only those APs that are a source of interference based on the data from the multiple STAs that will be served simultaneously. In many embodiments, the controller can use a threshold for interference level and only involve those APs in multi-AP coordination whose interference level is above this threshold. In several embodiments, the controller can also use this information to reduce the number of STAs that are involved in multi-AP coordination. For example, the controller can only involve STAs that receive interference levels above a certain threshold and/or are likely to receive interference levels above a certain threshold.

Many embodiments can use traffic related data, including traffic performance requirement data, for multi-AP coordination. In many embodiments, the STA can provide the AP with traffic related data for the purpose of multi-AP coordination resource management. The STA can provide the AP with one or more of the information items as set forth in Table 2.

TABLE 2
Information items related to traffic characteristics
that can be provided by the STA to AP

| Information items | Description |
|---|---|
| Traffic identifier | Information to identify the traffic type. |
| (TID) | For example, this can be a specific set |
| | of TIDs that may need to be served via |
| | multi-AP coordination. In another example, |
| | this can be the TCLAS (traffic classification) |
| | and TCLAS processing element to categorize |
| | the traffic that needs to be served with |
| | multi-AP coordination. |
| Performance | Performance metrics that may need to be met |
| metrics | for the traffic stream. Multi-AP coordination |
| | can only be used when criteria specified via |
| | performance metrics cannot be met otherwise. |
| | Performance metrics can be one or more |
| | of the items as elaborated in Table 3. |

TABLE 3
Information items that can be indicated as performance metrics

| Information items | Description |
|---|---|
| Tolerable | The amount of interference that the STA |
| interference | can tolerate for the given stream, e.g., |
| | SINR (signal to interference plus noise ratio) |
| | level, RSSI (received signal-to-noise indicator) |
| | from each interfering AP, among others. |
| Throughput | The throughput requirements for the stream, |
| requirement | e.g., MAC throughput, among others. |
| Data rate | The data rate requirements for the stream, |
| requirements | e.g., MCS, PHY rates, among others. |
| Delay bounds | The delay bounds that may need to be met |
| | for the stream, e.g., controller to |
| | STA delay bound, among others. |
| QoS characteristic | QoS characteristics element or one or more |
| information | of the information items present therein. |

In many embodiments, an STA can provide the various types of data (e.g., interference data from Table 1, traffic data from Table 2 and performance data from Table 3, among others) to the AP in a number of manners, including data frames and/or other types of signaling. In many embodiments, data can be provided via a multi-AP (MAP) coordination negotiation protocol. In particular, the data can be provided by the STA to the AP in a MAP coordination negotiation request frame. In many embodiments, a Stream Classification Service (SCS) request and response framework can be extended for MAP coordination purposes. STA can also populate other optional elements of the SCS request and response framework according to MAP criteria, for example, a TCLAS and TCLAS processing element. In certain embodiments, the STA can include an element with MAP coordination performance metrics inside the SCS descriptor element.

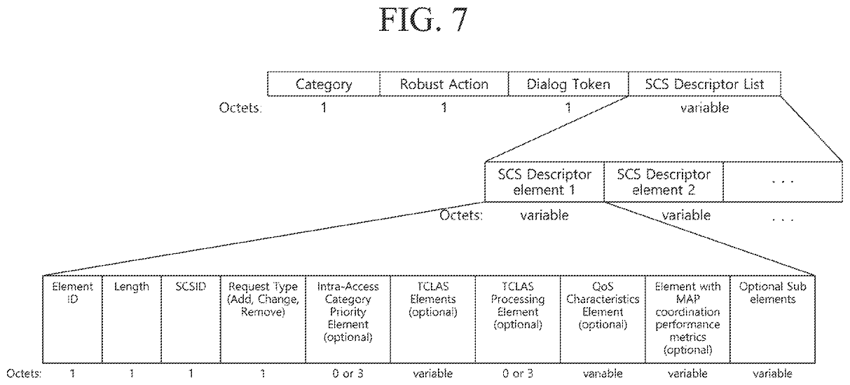

FIG. 7 illustrates an SCS request frame in accordance with an embodiment. The frame can include a Category field, a Robust Action field, a Dialog Token field, and an SCS descriptor list field.

The Category field may be set to a value that indicates a category of the SCS request frame that is an action frame. The Robust Action field may have a value associated with the SCR request frame format within predefined robust AV streaming category. The Dialog Token field may be used for matching action response with action requests when there are multiple, concurrent action requests. The SCS Descriptor List field may include one or more SCS Descriptor elements.

In particular, the SCS Descriptor element can include an Element ID field, Length field, SCSID field, Request Type field, Intra-Access Category Priority element field (optional), TCLAS elements field (optional), TCLAS processing element field (optional), QoS Characteristics element field (optional), Element with MAP Coordination Performance Metrics field (optional) and Optional Sub elements field.

The Element ID field may include information to identify a type of the SCS Descriptor element. The Length field may indicate a length of the SCS Descriptor element. The SCSID field may include information to identify the SCS descriptor element. The Request Type field can be set to indicate the request type (i.e., Add, Remove, and Change) of the SCS descriptor element. The Intra-Access Category Priority element field may be present when the Request Type field is equal to “Add” or “Change.” The TCLAS element field may include information on a traffic classification. The TCLAS processing element field may include information on a method of processing a traffic from an upper layer. The QoS Characteristics element field may include a set of parameters that define the characteristics and QoS expectations of a traffic flow. The Element with MAP Coordination Performance Metrics field can include information related to performance metrics that can be used for multi-AP coordination.

Many embodiments can include information in an independent frame and/or other types of frames. In many embodiments, upon receiving the information, an AP can provide the information to a controller device.

In many embodiments, upon receiving the data from one or more STAs, the controller can select only those APs and STAs that need multi-AP coordination to meet the performance metrics specified by the STA. The controller can determine the APs and STAs to involve in multi-AP coordination by combining the information from STA data reports as described herein. The APs and STAs can be selected such that it can meet the performance requirements specified by the STA for that particular traffic stream.

In many embodiments, only those APs and STAs that carry a certain type of traffic can be involved in multi-AP coordination. For example, the APs that serve STAs with latency sensitive traffic. In certain embodiments, the STA can provide information about the TIDs for which multi-AP coordination needs to be performed, and only those APs and STAs that have ongoing traffic for such TIDs can be involved in multi-AP coordination and/or can be given higher priority for multi-AP coordination.

In many embodiments, the controller device can determine the traffic types for which multi-AP coordination can be performed. For example, only devices that meet the traffic type requirements and their corresponding APs and interfering APs can be involved in multi-AP coordination or can be given higher priority for multi-AP coordination.

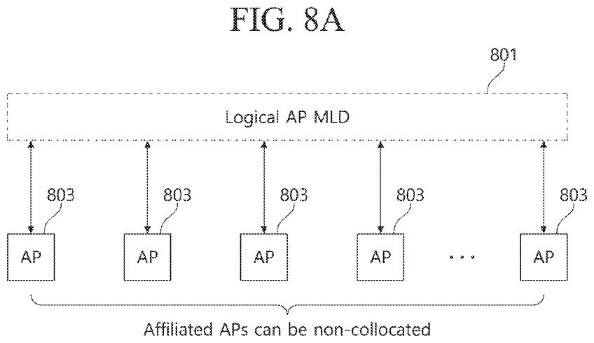

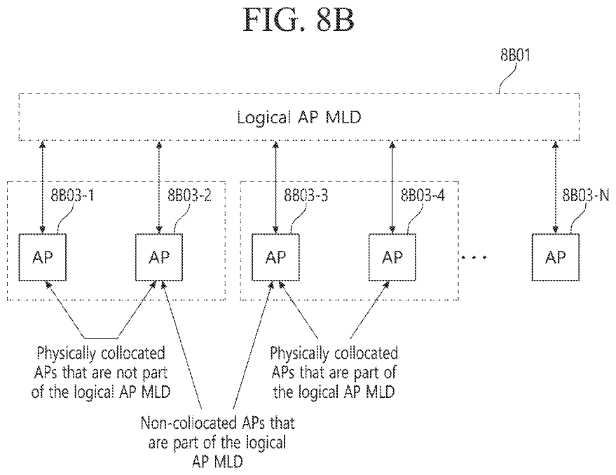

FIG. 8A shows a concept of a logical AP MLD in accordance with an embodiment.

The next generation Wireless Local Area Networks (WLANs) may aim to achieve low-latency with high reliability support. To attain this objective, one viable approach may involve the implementation of a logical AP MLD 801.

As depicted in FIG. 8A, a logical AP MLD 801 may be made up of a plurality of APs 803 which may be non-collocated. The logical AP MLD 801 may be different from the AP MLD specified in IEEE 802.11be, in that the AP MLD according to IEEE 802.11be considers collocated APs affiliated with the AP MLD. For example, when a first AP is affiliated with a first physical AP MLD and a second AP is affiliated with a second physical AP MLD, the first AP and the second AP may be referred to collectively as non-collocated APs. When a first AP and a second AP are affiliated with the same physical AP MLD, the first AP and the second AP may be referred to collectively as collocated APs.

In some embodiments, a plurality of APs 803 may be non-collocated. In some embodiments, one or more of the plurality of APs 803 may have a common data path to a router or a central controller. The APs shown in FIG. 8A may form the logical AP MLD 801. The logical AP MLD 801 may reduce the delays of association and authentication steps mentioned above as the STAs may not need to perform association and authentication during handover.

While the concept of the logical AP MLD 801 is very promising, a number of methods and procedures for setup and operation may be needed to realize this concept in next generation Wi-Fi networks.

First, it may be necessary to specify the operation of the logical MLD architecture. Some of the APs affiliated with the logical AP MLD may also be affiliated with a different physical AP MLD. FIG. 8B shows a concept of a logical AP MLD in accordance with another embodiment. As depicted in FIG. 8B, some of the AP STAs may be physically collocated and part of the logical AP MLD whereas some of the AP STAs can be collocated with APs that are not a part of the logical AP MLD. For example, the AP STA 8B03-2 which is a part of the logical AP MLD may be physically collocated with an AP STA 8B03-1 which is not a part of the logical AP MLD. The AP STA 8B03-3 which is a part of the logical AP MLD may be physically collocated with an AP STA 8B03-4 which is a part of the logical AP MLD. Methods and procedures that describe how various components of the logical AP MLD may be set up and interact with each other may be needed. Further, it may be necessary to define how various layers of the MAC architecture will be set up.

The discovery procedure also needs to be specified. Without a procedure to discover the logical AP MLD, the STA may not be aware of the existence of this framework at the AP side for mobility support. Consequently, the STA can fall back to one of the legacy procedures for mobility handling. Therefore, it may be necessary for an STA to be able to discover the logical AP MLD.

In addition, transmitting beacon frames may be necessary. The logical AP MLD needs to transmit beacon frames in order to announce its presence, update various parameters, capability announcement, among others. However, this can increase overhead as physical AP MLDs also transmit their own beacon frames. Therefore, a procedure to efficiently transmit beacon frames may be necessary. Further, it may be also necessary to design information that the logical AP MLD can share with the STA.

Procedures for link setup for logical AP MLD may also be necessary.

Finally, procedures for performing the handover using the logical AP MLD may be necessary.

Many embodiments can provide for resource management for a logical AP multi-link device (MLD). In particular, multiple AP MLDs can be co-deployed in a region. In order to minimize interference from each other, AP MLDs can share time and frequency resources amongst each other. In many embodiments, co-deployed AP MLDs can communicate with each other for coordinating and sharing time and frequency resources efficiently.

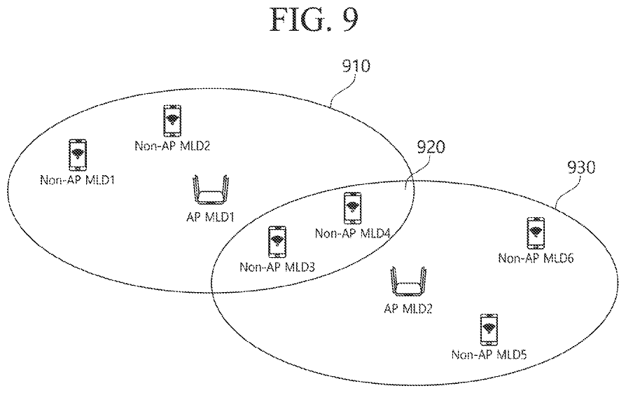

FIG. 9 illustrates an example of multiple AP MLDs deployed in an area. For the purposes of illustration and explanation, two AP devices are depicted in FIG. 9. The two AP devices are AP MLD1 and AP MLD2. A non-AP MLD1, a non-AP MLD2, and a non-AP MLD3 are non-AP MLDs associated with AP MLD1. A non-AP MLD4, a non-AP MLD5 and a non-AP MLD6 are non-AP MLDs associated with AP MLD2. As illustrated in the FIG. 9, non-AP MLD3 and non-AP MLD4 fall in an overlap region 920 of AP MLD1 and AP MLD2 and non-AP MLD1 and non-AP MLD2 fall only in the coverage area 910 of AP MLD1 and non-AP MLD5 and non-AP MLD6 fall only in the coverage area 930 of AP MLD2. However, such designs are primarily focused on single AP MLD operation.

Accordingly, many embodiments provide for multi-AP operation with which collocated and non-collocated APs can harmoniously share time and frequency resources with each other. Many embodiments provide for time and frequency division in multi-AP networks.

In many embodiments, different types of stacks can be configured to allocate resources, including local stacks and parallel stacks. In many embodiments, a local stack can refer to the setup of links from two or more collocated AP STAs.

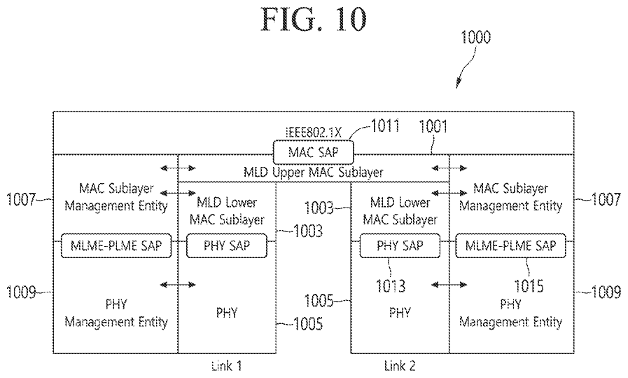

FIG. 10 shows a local stack in accordance with an embodiment.

For convenience of description, a setup of links from two collocated AP STAs as shown in FIG. 10 may be referred to as a local stack. The local stack may run on a physical AP MLD. For convenience, the local stack may be referred to interchangeably as collocated AP MLD.

As shown in FIG. 10, the local stack 1000 may operate on a plurality of links and comprise an MLD upper MAC sublayer 1001, MLD lower MAC sublayers 1003 for the links, PHY layers 1005 for the links, MAC sublayer management entities (MLME) 1007 for the links, PHY management entities (PLMEs) 1009 for the links, an MAC service access point (SAP) 1011, a PHY SAP 1013, and an MLME-PLME SAP 1015.

In an MLD, the MAC Sublayer may be divided into an MLD upper MAC sublayer 1001 and an MLD lower MAC sublayer 1003. The MLD upper MAC sublayer 1001 may perform functionalities that are common across all links, and the MLD lower MAC sublayer 1003 (shared with an AP or non-AP STA affiliated with the MLD) may perform functionalities that are local or specific to each link. Some of the functionalities may require joint processing of both the MLD upper MAC sublayer 1001 and the MLD lower MAC sublayer 1003.

The PHY management entity 1009 may perform management of the local PHY functions of the PHY layer 1005 in conjunction with the MLME 1007.

The MAC SAP 1011 may be located between an upper layer (802.1X) and the MAC sublayer as an interface for connecting the upper layer and the MAC sublayer. The MAC service access point MAC service data unit (MSDU) may be delivered as a unit between MAC service access points (SAPs) 1011.

The PHY SAP 1013 may be located between the MLD lower MAC sublayer 1003 and the PHY layer 1005 as an interface for connecting the MLD lower MAC sublayer 1003 and the PHY layer 1005.

The MLME-PLME SAP 1015 may be located between the MLME 1007 and the PLME 1009 as an interface for connecting the MLME 1007 and the PLME 1009.

In some embodiments, all the sublayers shown in the FIG. 10, for example, including the MLD upper MAC sublayer 1001 and the MLD lower MAC sublayer 1003, may operate on the same physical AP MLD.

For convenience, the setup of various layers depicted in FIG. 10 when the plurality of links, for example, including a link 1 and a link 2 are setup from two non-collocated APs may be referred to as a parallel stack. For convenience of description, the parallel stack may be referred to interchangeably as non-collocated AP MLD, single mobility domain AP MLD, logical AP MLD in this disclosure.

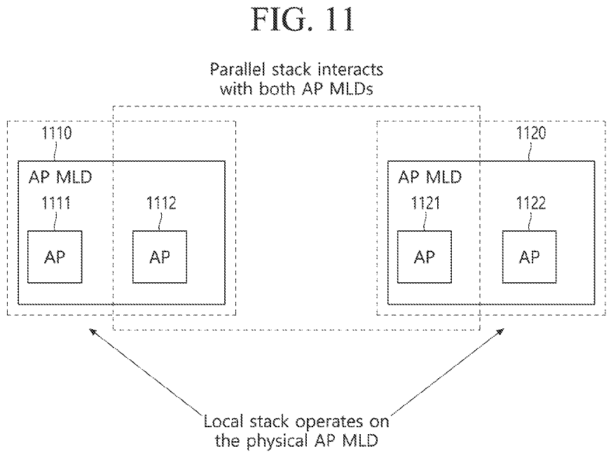

FIG. 11 shows how the parallel stack and the local stack operate in accordance with an embodiment.

FIG. 11 depicts a physical AP MLD 1110 and a physical AP MLD 1120. The physical AP MLD 1110 comprises an AP STA 1111 and an AP STA 1112. The physical AP MLD 1120 comprises an AP STA 1121 and an AP STA 1122.

As depicted in FIG. 11, a local stack for the physical AP MLD 1110 may operate on the physical AP MLD 1110 and a local stack for the physical AP MLD 1120 may operate on the physical AP MLD 1120 whereas the parallel stack can interact with both the AP MLDs.

Hereinafter, a Logical AP MLD architecture setup will be described referring to FIG. 11.

In some embodiments, all APs affiliated with an AP MLD may be a part of the parallel stack. For example, all APs 1111, 1112 affiliated with an AP MLD 1110 may be a part of the parallel stack.

In some embodiments, one or more APs affiliated with an AP MLD may be excluded from the parallel stack operation. For example, the AP 1112 affiliated with the AP MLD 1110 may be a part of the parallel stack and the AP 1111 affiliated with the AP MLD 1110 may be excluded from the parallel stack operation.

In some embodiments, the APs may be excluded from the parallel stack based on a number of conditions. For instance, some of the APs may be turned down for power saving, AP removal, among others, and may not be included in the parallel stack. In another example, when there may be too many APs and adding more APs may increase the complexity of the Logical AP MLD setup, some APs may be excluded from the parallel stack operation. In some embodiments, APs may be skipped if they do not support a particular feature for which the parallel stack will be used. For example, an AP may not be affiliated with the logical AP MLD if the AP does not support the mobility handover.

In some embodiments, an AP MLD may not be allowed to be a part of the logical AP MLD based on a lack of support for a particular feature. For example, an AP MLD may not be allowed to be a part of the logical AP MLD if the AP MLD does not support a feature that is required by devices that are using the Logical AP MLD or the feature for which the logical AP MLD is being setup. For example, the feature for which the logical AP MLD is being setup may be multi-AP coordination. In some embodiments, an AP MLD may not be allowed to be a part of the logical AP MLD stack if the central controller and the AP MLD are provided by different vendors and the implementations may not be compatible between the central controller and the AP MLD. In some embodiments, an AP MLD may not be allowed to be a part of the logical AP MLD when the AP MLD and the logical AP MLD are operated by different service providers and the AP MLD may not be qualified to become a part of the logical AP MLD setup by a service provider of the logical AP MLD.

In some embodiments, a plurality of components of the parallel stack may be implemented on different physical devices in different locations. For example, a first component of the parallel stack may be implemented on a first physical device in a first location and a second component of the parallel stack may be implemented on a second physical device in a second location. All the plurality of components of the parallel stack can interact over the backhaul to perform AP MLD operations.

In some embodiments, for the parallel stack operation, the MAC may be divided into two parts: a portion that is attributed to the collocated AP MLD and a portion that can be attributed to a different device. For example, the MAC may be divided into a lower MAC (LMAC) and an upper MAC (UMAC). The UMAC may handle various functionalities that are common for all the LMACs. For example, the common functionalities for all the LMACs may include authentication, association, disassociation, encryption, decryption, assignment of sequence number (SN) and packet number (PN), reorder buffer handling, replay detection, etc. The LMAC may handle other functionalities of the MAC that are specific to the link. For example, functionalities specific to the link may include A-MPDU De-aggregation, A-MPDU aggregation, MPDU Header+CRC creation, etc.

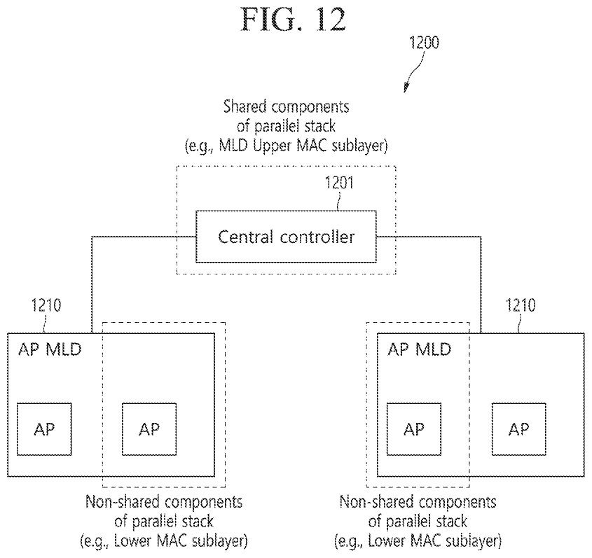

FIG. 12 shows operations of parallel stack in networks supporting multi-AP coordination in accordance with an embodiment.

As shown in FIG. 12, a network 1200 that supports multi-AP coordination (e.g., enterprise networks) may comprise a central controller 1201 and a plurality of AP MLDs. Each of the plurality of AP MLDs may comprise a plurality of AP STAs. In some embodiments, the network 1200 may further comprise one or more AP STAs which are not affiliated with any AP MLDs.

For the network 1200 that supports multi-AP coordination, the commonly shared components of the parallel stack (e.g., MLD upper MAC sublayer) may operate on the central controller 1201 as shown in FIG. 12.

In accordance with the embodiment as shown in FIG. 12, the parallel stack may comprise shared components included in the central controller 1210 and non-shared components included in the AP MLDs 1210. In some embodiments, the parallel stack may be set up by the MLD upper MAC sublayer of the central controller and the MLD lower MAC sublayers of the AP MLDs 1210.

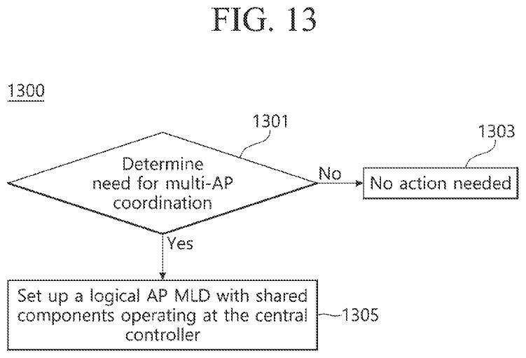

FIG. 13 shows a method for setting up the parallel stack in networks supporting multi-AP coordination in accordance with an embodiment.

Referring to FIG. 13, in operation 1301, the central controller 1201 may determine whether there is a need for multi-AP coordination. If the central controller 1201 determines there is no need for multi-AP coordination, the process proceeds to operation 1303 where no action is needed

If the central controller 1301 determines there is a need for multi-AP coordination, it sets up the logical AP MLD with the shared components operating at the central controller 1201 and non-shared components operating at the physical AP MLDs 1210, in operation 1305.

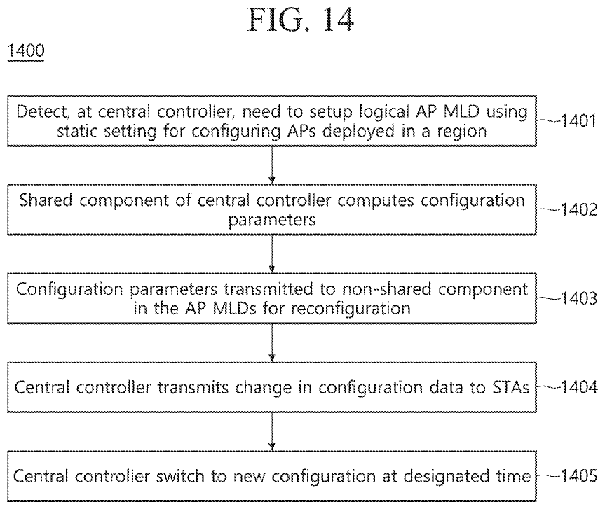

FIG. 14 shows a flow chart of an example process for static setting using a logical AP MLD in accordance with an embodiment.

Referring to FIG. 14, in operation 1401, the central controller 1201 may detect a need to setup a logical AP MLD using static setting for configuring APs deployed in a region. In operation 1402, the shared component operating at the central controller 1201 can compute configuration parameters. In operation 1403, the shared component operating at the central controller 1201 can transmit the configuration to non-shared component included in the AP MLDs 1210 for reconfiguration. In operation 1404, the central controller 1201 can transmit data regarding the change in configuration parameters to the STAs. In operation 1405, the central controller 1201 can switch to the new configuration at a designated time. In particular, when the APs are deployed in a region, the shared components operating at the central controller of the logical AP MLD stack can compute the appropriate configuration parameters and inform the non-shared components. In many embodiments, one or more of the APs involved in the multi-AP coordination can also compute the appropriate configuration parameters. The AP MLD can transmit a frame that includes the configuration data on one or more of the links setup between the AP MLD and the non-AP MLD in order to inform the non-AP MLD about the new configuration. This frame can include the new configuration and the designated time at which the reconfiguration can occur. Next, at the designated time, the AP MLD can switch to the new configuration. In many embodiments, the non-AP MLD can switch to the new configuration at the same time as the AP MLD.

In many embodiments, the non-AP MLDs can continue to remain associated with the logical AP MLD following a static setting process. In several embodiments, as the setting remains unchanged, the configuration can be applied to the local stack running on the physical AP MLD and the STAs can associate with the physical AP MLD. Following this, the logical AP MLD setup can be torn down and the local stack running on the physical AP MLD can continue to maintain the configuration.

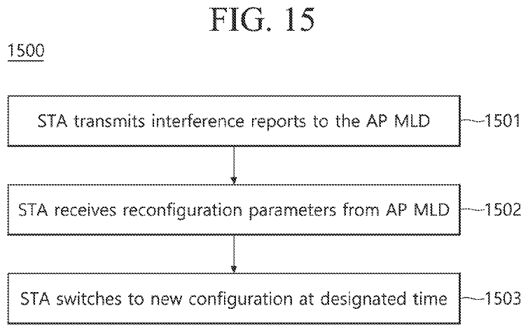

In many embodiments, the logical AP MLD can be used for a dynamic setting process. FIG. 15 shows a flow chart of an example STA side process for dynamic setting using a logical AP MLD in accordance with an embodiment.

The process 1500 can begin in operation 1501 where the STAs can provide interference reports to their respective AP MLDs. In many embodiments, the interference reports can be transmitted to a shared component of the logical AP MLD. In many embodiments, an interfering BSS can be identified based on the interference reports. In many embodiments the AP MLD can request reconfiguration of an interfering BSS via the logical AP MLD stack.

In operation 1502, the STA can receive reconfiguration parameters from the AP MLD.

In operation 1503, the STA can switch to the new configuration at a designated time.

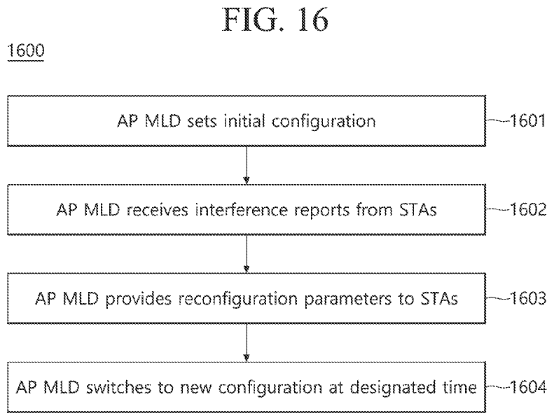

FIG. 16 shows a flow chart of an example AP side process for dynamic setting using a logical AP MLD in accordance with an embodiment.

The process 1600 can begin in operation 1601 where the AP MLDs can start with some initial configuration. In many embodiments, the initial configuration can be a default implementation configuration that is set by a vendor for the AP when the AP powers ON. In operation 1602, the AP MLDs can receive interference reports from their respective STAs. In particular, the STAs can provide interference reports to their respective AP MLD. In many embodiments, the interference reports can be provided to a shared component of the logical AP MLD. In many embodiments, an interfering BSS can be identified based on the interference reports. In many embodiments the AP MLD can request reconfiguration of an interfering BSS via the logical AP MLD stack. In many embodiments, the logical AP MLD stack can perform the reconfiguration of the corresponding AP MLDs to avoid interference.

In operation 1603, the AP MLD can provide reconfiguration parameters to the STAs.

In operation 1604, the AP MLD can switch to the new configuration at a designated time.

In many embodiments, based on the interference reports, the interfering BSSs can be identified. The AP MLD can then request reconfiguration of the interfering BSSs via the logical AP MLD stack. The logical AP MLD stack can perform reconfiguration of the corresponding AP MLDs to avoid interference. In many embodiments, the AP MLD itself can sense the interference based on other mechanisms present in the standard (e.g., OBSSPD).

In many embodiments, a non-AP MLD can provide interference reports to the AP MLD.

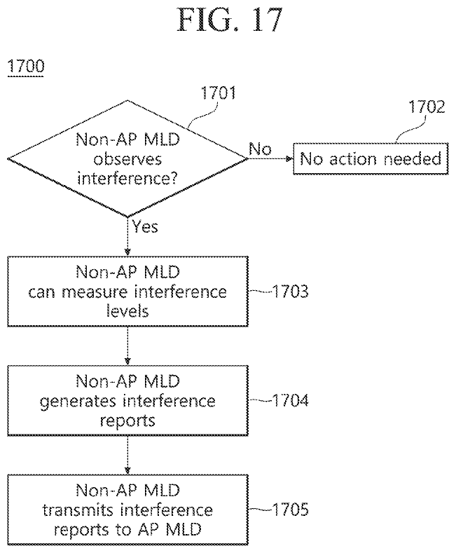

FIG. 17 shows a flow chart of an example process of an STA transmitting interference data reports in accordance with an embodiment. Although one or more operations are described or shown in particular sequential order, in other embodiments the operations may be rearranged in a different order, which may include performance of multiple operations in at least partially overlapping time periods.

The process 1700 can begin in operation 1701 where the non-AP MLD can determine whether it observes interference. In many embodiments, interference can be observed based on reports received from an STA that identify one or more APs that may be a source of interference (e.g., an interfering BSS can be identified based on the interference reports). If the non-AP MLD does not observe interference, the process proceeds to operation 1702 where no action is needed. If the non-AP MLD observes the interference, the process proceeds to operation 1703 where the non-AP MLD can measure interference levels. In operation 1704, the non-AP MLD can generate an interference data report. In operation 1705, the non-AP MLD can transmit the interference data report to an AP MLD. In many embodiments, the non-AP MLD can generate interference data reports in a periodic fashion. In several embodiments, the non-AP MLD can generate interference data reports in an on-demand manner whenever interference is observed.

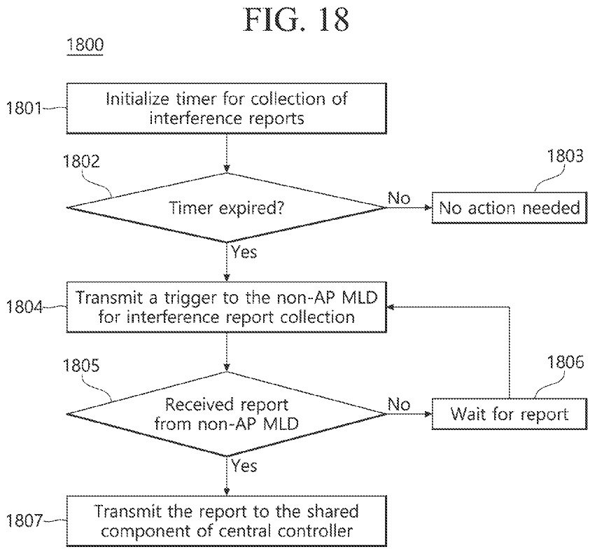

In many embodiments, the AP MLD can trigger the non-AP MLDs and collect interference data reports from. FIG. 18 shows a flow chart of an example process for an AP side triggering for collection of interference data reports from non-AP MLDs in accordance with an embodiment. Although one or more operations are described or shown in particular sequential order, in other embodiments the operations may be rearranged in a different order, which may include performance of multiple operations in at least partially overlapping time periods.

The process 1800 can begin at operation 1801 where the AP MLD can initialize a timer for the collection of interference reports. In operation 1802, the AP MLD determines whether the timer has expired, if the AP MLD determines that the timer has not expired, then the process proceeds to operation 1803 where no action is needed. If the AP MLD determines that the timer has expired, the process proceeds to operation 1804 where the AP MLD transmits a trigger to a non-AP MLD for interference report collection. In operation 1805, the AP MLD determines whether it received a report from the non-AP MLD. If the AP MLD determines that it did not receive a report, the process proceeds to operation 1806 where it waits for a report. If the AP MLD determines that it did receive a report, the process proceeds to operation 1807 where the AP MLD transmits the report to a shared component of the central controller.

In many embodiments, for reporting interference data, the non-AP MLD can transmit a frame to the AP MLD that includes one or more of the data items indicated in Table 4.

TABLE 4
Information items that can be present in interference
reports transmitted by non-AP MLD to AP MLD

| Information item | Description |
|---|---|
| BSSID | BSSID corresponding to the interfering BSS |
| Interference level | Interference level from the interfering BSS. |
| | e.g., signal strength from interfering |
| | BSS, RSSI, SINR, SNR. |
| Measurement | The measurement procedure for computing |
| procedure | interference level. e.g., if interference is |
| | averaged over a certain number of intervals, |
| | this information item can indicate the |
| | interval value, the number of intervals |
| | used to do the average and a code to indicate |
| | that the procedure to make this |
| | computation is averaging. |
| BSS color | The BSS color for the interfering BSS. |
| AP/STA | Identifier for the AP/STA from neighboring |
| identifier | BSS that cause the interference. |
| | e.g., MAC address. |

The non-AP MLD can transmit the information items to the AP MLD in an independent frame. In many embodiments, the information items can be transmitted to the AP MLD as a part of any of the existing frames in the standard (e.g., via the measurement request and response framework).

In many embodiments, the AP MLD can request a reconfiguration of a neighboring BSS via the logical AP MLD for long term adaptation. A reconfiguration for long term adaptation can include, for example, reconfiguration of bands/channels/bandwidth for operation, among other configuration settings.

In many embodiments, the reconfiguration can be done by the logical AP MLD as a short-term adaptation. For example, the logical AP MLD can share time and/or frequency resources on a short-term basis.

In many embodiments, the short-term adaptation can be done by sharing time resources by support of the logical AP MLD. When one of the APs that is affiliated with the logical AP MLD wins a TXOP, the logical AP MLD can allocate portions of the acquired TXOP to other APs affiliated with the logical AP MLD. These APs can share the same frequency resources (e.g., band, channel, bandwidth, etc.) with the AP that obtains the TXOP.

In many embodiments, when an AP affiliated with the logical AP MLD obtains a TXOP, it can inform the shared component of the logical AP MLD. Based on the interference reports generated by the non-AP MLDs associated with this AP MLD, the shared component can identify the interfering APs and their STAs. In many embodiments, a configuration can be applied to all APs affiliated with the logical AP MLD. The shared component stack can then pass one or more of the configuration settings, (e.g., information items shown in Table 5 below) to the non-shared component running on each AP MLD for division of time resources.

TABLE 5
Information items that can be passed by the shared
component to the non-shared components

| Information items | Description |
|---|---|
| Start time | Start time for each AP affiliated with the |
| | logical AP MLD |
| Duration | Duration for which each AP can transmit |

In many embodiments, the corresponding APs can then start their transmissions at the allocated start time and for the allocated duration as indicated by the shared component of the logical AP MLD.

In many embodiments, short-term adaptation can be performed by sharing frequency resources of the logical AP MLD. When one of the APs that is affiliated with the logical AP MLD wins a TXOP, the logical AP MLD can divide frequency resources to affiliated APs that interfere with the AP that obtained TXOP. These APs can share the same time resources with the AP that obtains the TXOP.

In many embodiments, when an AP affiliated with the logical AP MLD obtains a TXOP, it can inform the shared component of the logical AP MLD. Based on the interference reports generated by the non-AP MLDs associated with this AP MLD, the shared component identifies the interfering APs and their STAs. In certain embodiments, this scheme can be applied to all APs affiliated with the logical AP MLD. The shared component stack can then pass the frequency resources (e.g., channel, bandwidth) to the non-shared component running on each AP MLD for division of frequency resources.

The corresponding APs can then share the entire TXOP but on their respective frequency resources as indicated by the shared component of the logical AP MLD.

In many embodiments, the described processes can be used for cases not involving the logical AP MLD as well. If the APs are not a part of the logical AP MLD, they can still avoid interference to each other by sharing time and frequency resources (e.g., acquired TXOPs, frequency resources, etc.).

In many embodiments, a switching mechanism can be used to coordinate time and frequency resources. A switching between local and logical AP MLD stacks can be done to address interference issues.

In many embodiments, two sets of configurations can be maintained. The first configuration can be for the local stack and the second configuration can be for the parallel stack. For example, the local stack can be configured to operate on a channel in 5 GHz with 160 MHZ bandwidth and the parallel stack can be configured to operate on a different 5 GHz channel with a lower bandwidth so that it does not overlap with the local stack. The device can associate with the local AP MLD first. Further, STAs can transmit interference reports to their APs. Based on the interference reporting, one or more of the STAs that see interference can be moved from the local stack to the logical AP MLD stack.

FIG. 19 shows a flow chart of an example process for switching between a local and parallel stack in accordance with an embodiment. Although one or more operations are described or shown in particular sequential order, in other embodiments the operations may be rearranged in a different order, which may include performance of multiple operations in at least partially overlapping time periods.

The process 1900 can begin at operation 1901 where a central controller can configure local AP MLD and logical AP MLD stack parameters. In operation 1902, the central controller determines whether STA observes interference. In many embodiments, interference can be observed based on reports received from an STA that identify one or more APs that may be a source of interference (e.g., an interfering BSS can be identified based on the interference reports).

If the central controller does not observe interference, the process proceeds to operation 1903 where no action is necessary. If the central controller observes interference, the process proceeds to operation 1904 where the central controller transmits a frame to an STA to inform the STA of switch from local AP MLD to logical AP MLD. In response to receiving the information, the STA may switch from local AP MLD to logical AP MLD. In many embodiments, for switching the STA from the local to the logical AP MLD stack, the AP can transmit a frame to the STA to inform it about the switching event. The frame can include information shown in Table 6.

TABLE 6
Information that can be present in frame transmitted to STA
for switching STA from local to logical AP MLD

| Information fields | Description |
|---|---|
| Reason code | A reason code indicating the reason for |
| | switching the STA from local to logical |
| | AP MLD |
| Switching time | Time at which the switching can occur |

Upon receiving the frame from the AP, the STA can switch from the local to logical AP MLD at the indicated time. Different settings of the STA (e.g., BA settings) can be transferred internally from the local to logical AP MLD for efficient switching.

In many embodiments, the AP MLD can advertise its capability to setup logical AP MLD for the purpose of multi-AP operation (e.g., for time and frequency division).

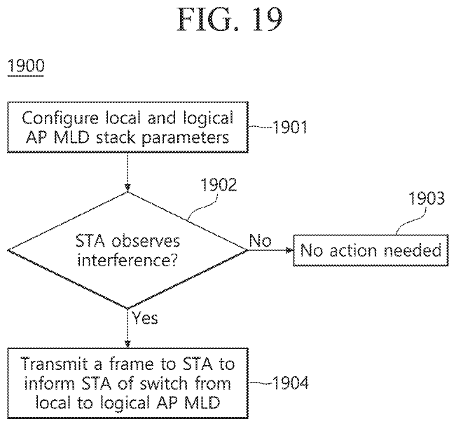

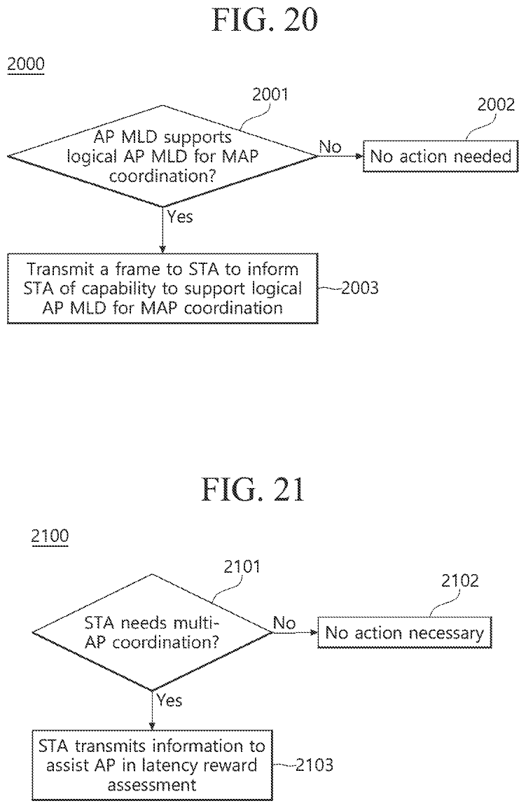

FIG. 20 shows a flow chart of an example process for capability advertisement for an AP MLD in accordance with an embodiment. Although one or more operations are described or shown in particular sequential order, in other embodiments the operations may be rearranged in a different order, which may include performance of multiple operations in at least partially overlapping time periods.

The process 2000 can begin at operation 2001 where the AP MLD can determine whether it supports logical AP MLD for MAP coordination. If the AP MLD does not support logical AP MLD for MAP coordination, the process proceeds to operation 2002 where no action is performed. If the AP MLD does support logical AP MLD for MAP coordination, the process proceeds to operation 2003, where the AP MLD can transmit a frame containing an indication of the ability to support logical AP MLD for MAP coordination to the STA. This frame can be a beacon frame, a probe response frame or any of the management frames that the AP MLD transmits. STAs that receive the frame can discover this setup and/or capability of the AP MLD to setup logical AP MLD for multi-AP operation.

In many embodiments, an AP can incur certain latency costs in order to participate in multi-AP coordination can. In particular, a coordinating AP may need to dedicate some of its time and frequency resources for performing coordination with a different AP in need of coordination. This coordination can involve time and frequency resource sharing, AP to AP communication overhead, among other types of overhead. This may cause some delays to the participating AP's own traffic. For example, the coordinating AP may be needed to terminate its TXOP early to release the channel to a neighboring AP which can cause some additional delay to its own STA's traffic. On the access side, there can be an airtime consumption from STA-side reporting of interference levels, among others. This airtime spent on overhead exchange can cause delays to other STA's traffic as the airtime could have been otherwise used for exchanging data instead, which can be another cost to the APs.

Multi-AP frameworks can also incur latency costs related to a backhaul framework. In particular, multi-AP coordination can include signaling and data overhead exchanged over the backhaul network, which can be for central controller to AP communication and/or AP to AP communication. The central controller may need to employ data management for sharing data amongst the APs. Many embodiments can use joint transmission, where data of each AP may need to be available at the other participating APs. Each AP may also need to perform signaling to exchange information necessary for multi-AP coordination, which can include, for example, trigger frames for triggering neighboring APs. This can result in various overhead increases, including in backhaul load, data management complexity, among other costs and may also result in an increase in latency for traffic flows that traverse over the backhaul network.

The overhead costs associated with coordination should result in a net reward or improvement for the coordination. In particular, the reward for coordination can be a reduction in interference and possible reduction in channel access duration which can provide a latency improvement for one or more STAs associated with the AP that is requesting multi-AP coordination.

In many embodiments, prior to participating in multi-AP coordination, a system may perform a cost/benefit analysis for performing the multi-AP coordination, which can include determining if the latency costs can be tolerated and if the latency reward arising from such cost is beneficial or not. In particular, the latency cost can increase with an increasing number of APs and STAs that are participating in multi-AP coordination and if a significant number of APs and STAs participate in multi-AP coordination, the costs can potentially outweigh the reward in some situations. In certain situations, a reward may not create any additional difference in performance for an STA (e.g., the latency improvement from multi-AP coordination does not result in a significant difference in user experience of an STA). Likewise, in certain situations, an AP may not be able to estimate and/or quantify a reward as well (e.g., for uplink traffic, AP may not know the latency encountered or the improvement experienced). Accordingly, many embodiments provide for processes and signaling that can enable an AP to make decisions to limit the cost of multi-AP coordination. In many embodiments, the STA can provide information to the AP to enable the AP to assess the potential reward from performing multi-AP coordination.

FIG. 21 shows a flow chart of an example STA side process to enable latency reward assessment at the AP in accordance with an embodiment. Although one or more operations are described or shown in particular sequential order, in other embodiments the operations may be rearranged in a different order, which may include performance of multiple operations in at least partially overlapping time periods.

The process 2100 can begin at operation 2101 where the STA determines whether the STA needs multi-AP coordination. If the STA determines that it does not need multi-AP coordination, the process proceeds to operation 2102 where no action is necessary. If the STA determines that it needs multi-AP coordination, the process proceeds to operation 2103 where the STA transmits data to an AP to assist the AP in a latency reward assessment. In many embodiments, the STA can transmit, to the AP, a frame that includes data with at least one or more of the information items indicated in Table 7.

TABLE 7
Information that the STA can provide for
enabling latency reward assessment

| Information item | Description |
|---|---|
| Interfering BSS | An indicator of the BSS from which the |
| identifier | interference is encountered. e.g., BSS ID |
| Interfering AP | An indicator of the AP from which the |
| identifier | interference is faced. e.g., AP MAC address |
| Interfering STA | An indicator of the STA from which the |
| identifier | interference is faced. e.g., STA MAC address |
| Interference | STA side assessment on how much improvement |
| improvement | it expects to see if the interference indicated |
| expectation | from the AP and STA pair above is eliminated |
| | via multi-AP coordination. e.g., expected |
| | improvement in SINR |
| Data rate | STA side assessment on how much |
| improvement | improvement it expects in the data rate for |
| | packet transmission (considering factors |
| | such as SINR, rate adaptation, mode of |
| | transmission) if the interference from the AP |
| | and STA pair above is eliminated. |
| Expected | STA side assessment on how much improvement |
| throughput | it expects in the throughput if the interference |
| improvement | from the AP and STA pair above is eliminated. |
| | This can also be an approximate estimate. |
| Expected latency | STA side assessment on how much improvement |
| improvement | it expects in the latency if the interference |
| | from the AP and STA pair above is eliminated. |
| | e.g., if STA is deferring transmissions and facing |
| | delay, STA can compute the uplink latency |
| | improvement if those delays are not encountered. |
| Link identifier | The link to which this information corresponds to. |
| | e.g., the link ID |
| Traffic identifier | The traffic to which this information corresponds |
| | to. e.g., TID |
| Classification | If the traffic for which this information is provided |
| identifier | has a classification identifier. e.g., SCS ID. |

The information can be transmitted by the STA in an independent frame and/or in other types of appropriate frames in the standard. The above information can be transmitted by the STA on its own (e.g., when it encounters a performance issue) and/or when requested by the AP.

In many embodiments, with multi-link operation, the information can be transmitted by the non-AP MLD on one or more of the links that are setup between itself and the AP MLD. Upon receiving the information, the AP MLD can understand which link the information corresponds to based on the link ID information. In many embodiments, there can be an implicit indication by transmitting the frame on the same link on which interference is experienced. The AP can also use the other information that the STA has provided to the AP in other frameworks linked to this traffic stream. For example, by looking at the SCS ID, the AP can connect this information with the information provided in QoS characteristic element to help in the coordination.

In many embodiments, upon receiving the information from the STA, the AP can take actions to mitigate the interference via multi-AP coordination. In order to understand if the action resulted in the desired reward or not, the AP can request a feedback from the STA. The feedback can be provided via a frame transmitted by the STA to the AP and can contain at least one or more of the information items indicated in Table 8 below.

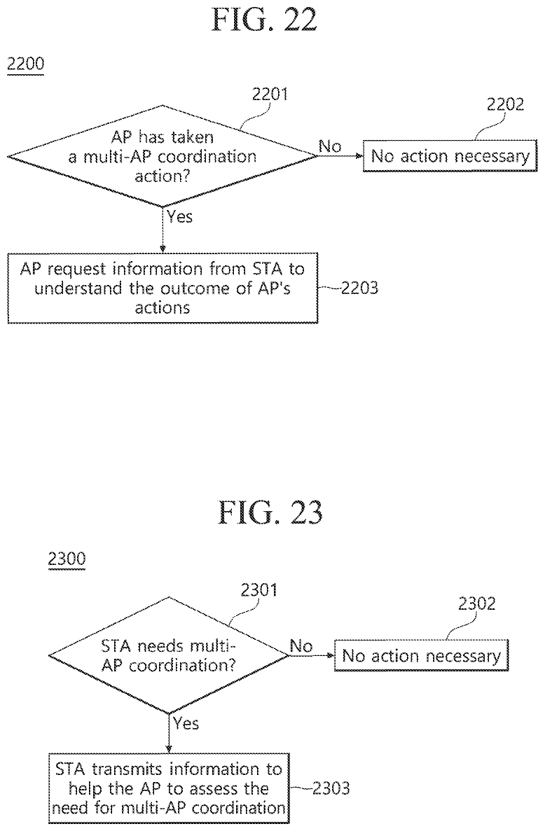

FIG. 22 shows a flow chart of an example AP side process for assessing if its actions resulted in a reward in accordance with an embodiment. Although one or more operations are described or shown in particular sequential order, in other embodiments the operations may be rearranged in a different order, which may include performance of multiple operations in at least partially overlapping time periods.

The process 2200 can begin at operation 2201 where the AP determines whether the AP has taken a multi-AP coordination action. If the AP determines that it has not taken a multi-AP coordination action, the process proceeds to operation 2202 where no action is necessary. If the AP determines that it has taken a multi-AP coordination process, the process proceeds to operation 2203 where the AP can request data related to performance improvements from the STA to understand the outcome of the AP's action.

TABLE 8
Information data that the STA can provide
to the AP to use for determining the outcome/improvement,
if any, associated with AP's coordination actions

| Information item | Description |
|---|---|
| Interfering BSS | An indicator of the BSS from which the interference |
| identifier | is encountered. e.g., BSS ID |
| Interfering AP | An indicator of the AP from which the interference |
| identifier | is faced. e.g., AP MAC address |
| Interfering STA | An indicator of the STA from which the interference |
| identifier | is faced. e.g., STA MAC address |
| Interference | STA side assessment on how much |
| improvement | improvement it experienced after multi-AP |
| experienced | coordination. e.g., improvement in SINR |
| Data rate | STA side assessment on how much improvement |
| improvement | it experienced in the data rate for |
| | packet transmission after multi-AP coordination. |
| Expected | STA side assessment on how much |
| throughput | improvement it experienced in the throughput |
| improvement | after multi-AP coordination. This can also be an |
| | approximate estimate. |
| Expected latency | STA side assessment on how much improvement |
| improvement | it experienced in the latency after multi-AP |
| | coordination. e.g., if STA was deferring |
| | transmissions and facing delay, STA can |
| | compute the uplink latencyimprovement |
| | in those delays after multi-AP coordination. |
| Link identifier | The link to which this information corresponds. |
| | e.g., the link ID |
| Traffic identifier | The traffic to which this information |
| | corresponds. e.g., TID |
| Classification | If the traffic for which this information is provided |
| identifier | has a classification identifier. e.g., SCS ID. |

The improvement data can be transmitted by the STA in an independent frame or in other types of the frame as appropriate for the standard. The improvement information can be transmitted by the STA on its own (e.g., if a performance issue persists) and/or when requested by the AP.

In the case of multi-link operation, the data can be transmitted by the non-AP MLD on one or more of the links that are setup between itself and the AP MLD. Upon receiving the information, the AP MLD can understand which link the information corresponds to based on the link ID information. In many embodiments, there can be in implicit indication by transmitting the frame on the same link for which multi-AP coordination action has been taken. AP MLD can also request the above information on one or more of the links setup between the AP MLD and the non-AP MLD.

In many embodiments, the STA can provide information to the AP to enable the AP to assess the need for multi-AP coordination for the STA's traffic.

FIG. 23 shows a flow chart of an example STA side process to enable the AP to assess its multi-AP coordination requirement in accordance with an embodiment. Although one or more operations are described or shown in particular sequential order, in other embodiments the operations may be rearranged in a different order, which may include performance of multiple operations in at least partially overlapping time periods.

The process 2300 can begin at operation 2301 where the STA determines whether it needs multi-AP coordination action. If the STA determines that it does not need multi-AP coordination, the process proceeds to operation 2302 where no action is necessary. If the STA determines that it needs multi-AP coordination, the process proceeds to operation 2303 where the STA can transmit information to help the AP to assess the needs for multi-AP coordination. In many embodiments, the STA can provide this information by transmitting a frame with data related to the information items indicated in Table 9 below.

TABLE 9
Information items that STA can provide to the AP for
enabling assessment of multi-AP coordination requirement.

| Information item | Description |
|---|---|
| Stream identifier | An identifier for the stream to which this packet |
| | belongs to. e.g., SCS ID |
| Traffic identifier | An identifier for the traffic to which this packet |
| | belongs to. e.g., TID |
| Traffic direction | The direction of the traffic. E.g., DL, UL. |
| Delay tolerance | The maximum delay tolerance of the frame of a |
| | particular traffic stream. If the delay tolerance |
| | is exceeded, the packet can be dropped from the |
| | STA queue. For downlink traffic, the delay |
| | tolerance can be the controller to the STA delay. |
| | This can help the MAP framework to select |
| | APs for coordination such that the end to end |
| | delay is reduced. E.g., if there are one or more |
| | APs that have high load for video traffic and if |
| | involving such APs results in the delay tolerance |
| | to get exceeded and if the MAP framework can |
| | exclude such APs but still meet the performance |
| | requirements of the STA (despite the interference), |
| | then the MAP framework can exclude them. |
| Timing | The STA can provide timing information to the AP |
| information | to enable the AP to assess the STA's urgency |
| | of transmission. E.g., the STA can provide |
| | packet enqueue time to the AP for one or more |
| | of the frames that are enqueued at the STA side. |
| | The AP can use this information to assess the |
| | time left before the packet is dropped from the |
| | STA queue. This assessment can help the AP |
| | to know if it can tolerate the cost of sharing |
| | its resources with other APs for multi-AP |
| | coordination. It can also help the AP to |
| | understand the prioritization that needs to be |
| | provided to some STAs for multi-AP |
| | coordination. AP can also reduce the number of |
| | STAs that are served via multi-AP coordination |
| | based on urgency criteria. |
| Throughput | The throughput that the STA needs to be able |
| requirements | to support the traffic stream. |
| Interference | The interference that the STA can tolerate for this |
| tolerance | particular stream. e.g., SINR values |
| Latency | The latency that the STA currently experiences. |
| experienced | |
| Interference | The interference that the STA currently experiences |
| experienced | |
| Throughput | The throughput that the STA currently experiences. |
| experienced | |

The information can be transmitted by the STA to the AP in an independent frame or in other types frames as appropriate to the standard. The information can be transmitted by the STA on its own (e.g., if a performance issue persists) and/or when requested by the AP. In the case of multi-link operation, the information can be transmitted by the non-AP MLD on one or more of the links that are setup between itself and the AP MLD.

Upon receiving the information, the AP can assess which STAs have a higher need for multi-AP coordination. An AP can identify the STAs whose performance requirements can be met without any multi-AP coordination even if the STA faces interference from neighboring BSSs. The AP can use this to reduce the cost of multi-AP coordination by reducing the STAs that are served via multi-AP coordination.

In many embodiments, the AP can reduce the latency cost from multi-AP coordination by providing a multi-AP coordination membership to STAs. The AP can select STAs for multi-AP coordination by using the various types of information that can be obtained from the STAs and supplementing that information from other information that the AP has based on any other sources (e.g., AP's own measurements). In many embodiments, for the STAs that the AP provides membership to, the AP can reduce the latency cost for the backhaul framework and also the latency cost to the AP participating in coordination by reducing the number of APs that it coordinates with.

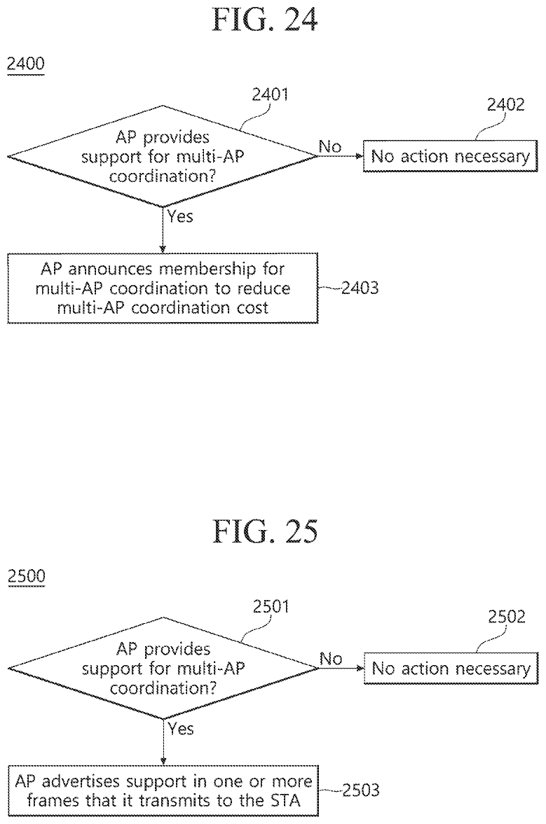

FIG. 24 shows a flow chart of an example AP side process for membership announcement for multi-AP coordination in accordance with an embodiment. Although one or more operations are described or shown in particular sequential order, in other embodiments the operations may be rearranged in a different order, which may include performance of multiple operations in at least partially overlapping time periods.

The process 2400 can begin at operation 2401 where the AP determines whether the AP provides support for multi-AP coordination. If the AP determines that it does not provide support for multi-AP coordination, the process proceeds to operation 2402 where no action is necessary. If the AP determines that it does provide support for multi-AP coordination, the process proceeds to operation 2403 where the AP can announce membership for multi-AP coordination to reduce multi-AP coordination cost. For announcing the membership, the AP can transmit a frame to the STA that includes one or more of the information items indicated in Table 10.

TABLE 10
Information items that can be present in a membership
management frame transmitted by the AP to the STA

| Information items | Description |
|---|---|
| STA identifier | An identifier of the STA for which this information |
| | corresponds to. e.g., the STA MAC address |
| Coordinating APs | The APs with which the multi-AP coordination will |
| | happen for serving the STA's traffic. e.g., the |
| | AP MAC address, SSID, etc. The STA can also |
| | include interference and other information for only |
| | these APs in its reports unless the interference |
| | values from the other APs changes suddenly. |
| | This can help to reduce the feedback overhead from |
| | reporting. The coordinating APs can be reduced |
| | to optimize the cost of multi-AP coordination. |
| Membership | The duration for which the membership has been |
| duration | granted. The AP can consider to renew the |
| | membership after this window based on STA's |
| | reporting. AP can also consider to cancel the |
| | membership if STA's traffic's performance |
| | requirements can be met without multi-AP |
| | coordination. |
| Membership | The membership status of the STA. e.g., this can |
| status | be a one bit value that is set to 1 when |
| | membership is granted or maintained and to 0 if |
| | membership is revoked. |

The information can be transmitted by the AP to the STA in an independent announcement frame and/or in any of the frames existing in the standard. (e.g., management frames such as beacons). For MLO operation, the information can be transmitted by an AP MLD to a non-AP MLD on one or more of the links setup between the AP MLD and non-AP MLD. In many embodiments, the AP can give membership to one or more of the STAs without any announcement. In many embodiments, the number of coordinating APs can be reduced such that the cost of multi-AP coordination is reduced. To reduce this cost the AP can consider various factors such as the delay tolerance requirement of the STA, the interference level from those APs, among other factors and whether a performance requirement of the STA can be met without involving these APs.

In many embodiments, the AP can advertise the capability to provide multi-AP coordination to the STA. The AP can advertise this capability in one or more of the frames (e.g., management frames such as beacon frames, among others) that the AP transmits to the STA. An STA that receives this indication can understand the AP's support and provide feedback to the AP accordingly.

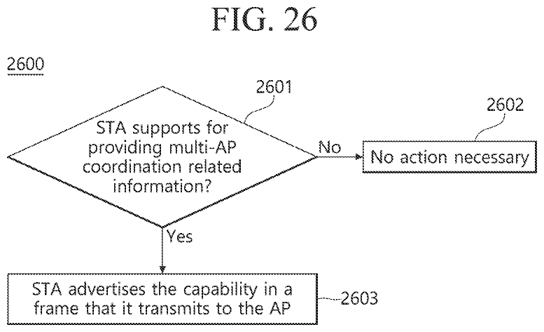

FIG. 25 shows a flow chart of an example AP side process for capability advertisement in accordance with an embodiment. Although one or more operations are described or shown in particular sequential order, in other embodiments the operations may be rearranged in a different order, which may include performance of multiple operations in at least partially overlapping time periods.

The process 2500 can begin at operation 2501 where the AP determines whether the AP can provide support for multi-AP coordination. If the AP determines that it can not provide support for multi-AP coordination, the process proceeds to operation 2502 where no action is necessary. If the AP determines that it can provide support for multi-AP coordination, the process proceeds to operation 2503 where the AP can advertise its support for multi-AP coordination in one or more frames that it transmits to the STA.

In many embodiments, the STA can also advertise its capability to provide support to the AP. The STA can advertise this capability in one or more of the frames that the STA transmits to the AP. (e.g., management frames such as probe responses). The AP that receives this indication can understand the STA's support and activate necessary procedures accordingly.

FIG. 26 shows a flow chart of an example STA side process for advertising a capability in accordance with an embodiment. Although one or more operations are described or shown in particular sequential order, in other embodiments the operations may be rearranged in a different order, which may include performance of multiple operations in at least partially overlapping time periods.

The process 2600 can begin at operation 2601 where the STA can determine whether the STA provides supports for providing multi-AP coordination related information. If the STA determines that it does not provide support for multi-AP coordination, the process proceeds to operation 2602 where no action is necessary. If the STA determines that it can provide support for multi-AP coordination, the process proceeds to operation 2603 where the STA can transmit one or more frames that advertise and/or include information regarding the capability to support multi-AP coordination to the AP.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) device in a wireless network, the AP device comprising:
a memory;
a processor coupled to the memory, the processor configured to:
receive information related to multi-AP coordination from a station (STA);
select at least one other AP that is not affiliated with the AP device based on the information;
communicate with the at least one other AP to perform multi-AP coordination; and
communicate with the STA in coordination with the at least one other AP.

2. The AP device of claim 1, wherein the information is received from the STA in an unsolicited manner or the information is solicited by the AP device.

3. The AP device of claim 1, wherein the information includes interference information of an interference from the at least one other AP to the STA.

4. The AP device of claim 3, wherein the processor is configured to:
select the at least one other AP to perform multi-AP coordination based on a level of interference.

5. The AP device of claim 4, wherein the processor is configured to:
select the at least one other AP to perform multi-AP coordination when the level of interference is above a threshold.

6. The AP device of claim 1, wherein the processor is configured to identify an interference based on a link on which the information is provided from at the STA.

7. The AP device of claim 1, wherein the processor is configured to:
select the at least one AP based on traffic information included in the information, wherein the traffic information provides performance metrics that need to be met for a traffic stream or a traffic identifier that identifies a type of traffic that needs to be served for the traffic stream.

8. The AP device of claim 1, wherein the processor is configured to:
calculate a metric that predicts a change in performance from performing the multi-AP coordination; and
determine that the metric satisfies a threshold.

9. The AP device of claim 1, wherein the information comprises information indicating expected improvement at the STA if a source of interference is eliminated, wherein the improvement is at least one of an expected improvement in signal to interference and noise ratio (SINR), a data rate improvement, a throughput improvement, or a latency improvement.

10. The AP device of claim 1, wherein the processor is configured to:
announce information related to membership for multi-AP coordination to the STA;
wherein the information related to the membership comprises information regarding one or more APs involved in the multi-AP coordination.

11. A station (STA) device in a wireless network, the STA device comprising:
a memory;
a processor coupled to the memory, the processor configured to:
transmit information related to multi-AP coordination to a first AP, wherein the information comprises interference information that identifies a second AP that is not affiliated with the first AP; and
receive configuration information from the first AP, wherein the configuration information has been configured based on a performed multi-AP coordination with the second AP.

12. The STA device of claim 11, wherein the information is transmitted in an unsolicited manner or the information is solicited by the first AP.

13. The STA device of claim 11, wherein the information includes interference information of an interference from the second AP.

14. The STA device of claim 11, wherein the information is transmitted on a same link on which an interference is experienced from the second AP.

15. The STA device of claim 11, wherein the information includes traffic information, wherein the traffic information provides performance metrics that need to be met for a traffic stream or a traffic identifier that identifies a type of traffic that needs to be served.

16. The STA device of claim 13, wherein the information comprises information indicating an expected improvement if a source of interference is eliminated, wherein the improvement is at least one of an expected improvement in signal to interference and noise ratio (SINR), a data rate improvement, a throughput improvement, or a latency improvement.

17. The STA device of claim 11, wherein the processor is configured to:
receive information related to membership for multi-AP coordination from the AP;
wherein the information related to the membership comprises information regarding one or more APs involved in the multi-AP coordination.

18. A computer-implemented method for facilitating communication in a wireless network, the method comprising:
receiving, by an access point (AP), information related to multi-AP coordination from a station (STA);
selecting, by the AP, at least one other AP that is not affiliated with the AP based on the information;
communicating, by the AP, with the at least one other AP to perform multi-AP coordination; and
communicating, by the AP, with the STA in coordination with the at one other AP.

19. The computer-implemented method of claim 18, wherein the information is received from the STA in an unsolicited manner or the information is solicited by the AP device.

20. The computer-implemented method of claim 18, wherein the information includes interference information of an interference from the at least one other AP to the STA.
